(19) United States
(12) Patent Application Publication
(10) Pub. No.: US 2024/0151543 A1
(43) Pub. Date: May 9, 2024

(54) INFORMATION PROCESSING DEVICE

(71) Applicant: TOYOTA JIDOSHA KABUSHIKI KAISHA, Toyota-shi (JP)

(72) Inventors: Osami HASHIMOTO, Mishma-shi (JP); Hiroki TASHIMA, Fujisawa-shi (JP); Toshihiko INOUE, Nagoya-shi (JP); Kazuma TOYA, Anjo-shi (JP); Takashi TAZOE, Nagoya-shi (JP); Ryota BINGO, Nisshin-shi (JP); Kosuke SAKAKIBARA, Toyota-shi (JP)

(73) Assignee: TOYOTA JIDOSHA KABUSHIKI KAISHA, Toyota-shi (JP)

(21) Appl. No.: 18/449,982

(22) Filed: Aug. 15, 2023

(30) Foreign Application Priority Data
Nov. 9, 2022 (JP) 2022-179922

(51) Int. Cl. G01C 21/34; G01C 21/00

(52) U.S. Cl. CPC G01C 21/3461; G01C 21/3848; G01C 21/3852

(57) ABSTRACT

An in-vehicle device as an information processing device includes an acquisition unit that acquires the latest satellite image of a region including a traveling road of a vehicle at predetermined time intervals, a detection unit that detects at least one of a change in the shape of the traveling road and an obstacle on the traveling road based on the satellite image acquired by the acquisition unit, and an output unit that outputs a detection result by the detection unit.

### CROSS-REFERENCE TO RELATED APPLICATION

This application claims priority to Japanese Patent Application No. 2022-179922 filed on Nov. 9, 2022, incorporated herein by reference in its entirety.

### BACKGROUND

### 1. Technical Field

The present disclosure relates to an information processing device.

### 2. Description of Related Art

Japanese Unexamined Patent Application Publication No. 2010-176506 (JP 2010-176506 A) discloses a technique related to an information transmission and reception system that performs route guidance when a disaster occurs. The information transmission and reception system includes a mobile device and an information distribution institution. The mobile device is mounted on a vehicle and includes a passing information transmission unit. The passing information transmitting unit transmits passing information indicating the road on which the vehicle has passed and size information of the vehicle to the information distribution institution. The information distribution institution updates and distributes disaster road information based on the received passing information and the size information.

### SUMMARY

However, the above-described related art relies on information transmitted from the mobile device of the vehicle to the information distribution institution. Therefore, there is a possibility that, when such information is insufficient, the disaster information on the traveling road of the vehicle cannot be provided, and there is room for improvement in this respect.

In view of the above, it is an object of the present disclosure to provide an information processing device capable of providing disaster information on a traveling road of a vehicle without depending on the information from the vehicle.

An information processing device according to claim 1 includes: an acquisition unit that acquires a latest satellite image of a region including a traveling road of a vehicle at a predetermined time interval; a detection unit that detects at least one of a change in a shape of the traveling road and an obstacle on the traveling road based on the satellite image acquired by the acquisition unit; and an output unit that outputs a detection result by the detection unit.

According to the above configuration, the acquisition unit acquires the latest satellite image of the region including the traveling road of the vehicle at the predetermined time intervals. In addition, the detection unit detects at least one of a change in the shape of the traveling road and an obstacle on the traveling road based on the satellite image acquired by the acquisition unit. Further, the output unit outputs the detection result by the detection unit. Therefore, it is possible to provide disaster information on at least one of a change in the shape of the traveling road and an obstacle on the traveling road without depending on the information from the vehicle.

In the information processing device of the present disclosure according to claim 2, in the configuration according to claim 1, the detection unit further detects embankment around the traveling road based on the satellite image acquired by the acquisition unit.

According to the above configuration, since the detection unit further detects the embankment around the traveling road based on the satellite image acquired by the acquisition unit, it is possible to provide the information on the embankment around the traveling road. This makes it possible to understand the disaster risk caused by the embankment.

The information processing device of the present disclosure according to claim 3 includes, in the configuration according to claim 1, a rank assignment unit that assigns a danger level rank to a section that is a divided section of the traveling road based on the satellite image acquired by the acquisition unit, and the output unit further outputs the danger level rank assigned by the rank assignment unit in association with a section of the traveling road.

According to the above configuration, the rank assignment unit assigns the danger level rank to the section that is a divided section of the traveling road based on the satellite image acquired by the acquisition unit, and the output unit further assigns the danger level rank assigned by the rank assignment unit to the section in the traveling road in association with the section. Therefore, it is possible to provide the information on the danger level rank of each section of the traveling road without depending on the information from the vehicle.

The information processing device of the present disclosure according to claim 4 includes, in the configuration according to claim 3, a reception unit that receives information on each of a current position of the vehicle and a destination, a route search unit that searches for a route from the current position of the vehicle to the destination and having the danger level rank that is lower than a predetermined rank based on the information received by the reception unit and the danger level rank assigned by the rank assignment unit, and a route presentation unit that outputs the route searched by the route search unit.

According to the above configuration, the reception unit receives the information on each of the current position of the vehicle and the destination. The route search unit searches for the route from the current position of the vehicle to the destination and having the danger level rank that is lower than the predetermined rank based on the information received by the reception unit and the danger level rank assigned by the rank assignment unit, and the route presentation unit outputs the route searched by the route search unit. Therefore, it is possible to provide information on a route with a low danger level without depending on information from the vehicle.

In the information processing device of the present disclosure according to claim 5, in the configuration according to claim 3, the rank assignment unit estimates a danger level of each section of the traveling road using a machine learning model, and assigns the danger level rank based on the estimated danger level.

According to the above configuration, since the danger level is estimated using the machine learning model, it is possible to present a danger level rank with higher accuracy.

As described above, according to the information processing device of the present disclosure, it is possible to provide the disaster information on the traveling road of the vehicle without depending on information from the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a schematic configuration of an information system according to an embodiment;

FIG. 2 is a block diagram illustrating an example of a hardware configuration of the in-vehicle device according to the embodiment;

FIG. 3 is a diagram illustrating an exemplary functional configuration of a CPU in ECU according to the embodiment;

FIG. 4 is a flow chart illustrating an exemplary flow of a disaster-information outputting process according to the embodiment; and

FIG. 5 is a flow chart illustrating an exemplary flow of a route guidance process according to embodiment.

### DETAILED DESCRIPTION OF EMBODIMENTS

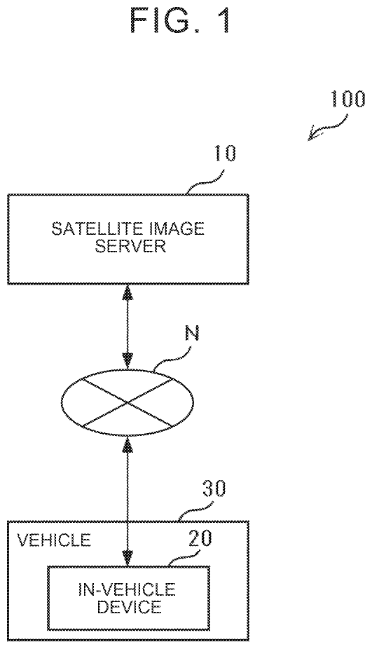

Hereinafter, an information processing device according to an embodiment of the present disclosure will be described with reference to FIG. 1 to FIG. 5.

### Structure of the Embodiment

FIG. 1 shows an example of a schematic configuration of an information system 100 according to the present embodiment. As illustrated in FIG. 1, the information system 100 includes a satellite image server 10 and an in-vehicle device 20. The in-vehicle device 20 is an example of an information processing device. The in-vehicle device 20 is mounted on the vehicle 30. In addition, the in-vehicle device 20 has a function as a navigation device. The number of vehicles 30 on which the in-vehicle device 20 is mounted is not limited to the number shown in FIG. 1. The satellite image server 10 and the in-vehicle device 20 are connected to each other through a network N.

In the satellite image server 10, satellite images, which are ground images regularly captured by an artificial satellite from the sky, are sequentially stored. Further, the satellite image server 10 stores a satellite image, a shooting date and time of the satellite image, and a shooting location of the satellite image in association with each other. The satellite image server 10 is capable of providing the latest satellite image for each shooting location.

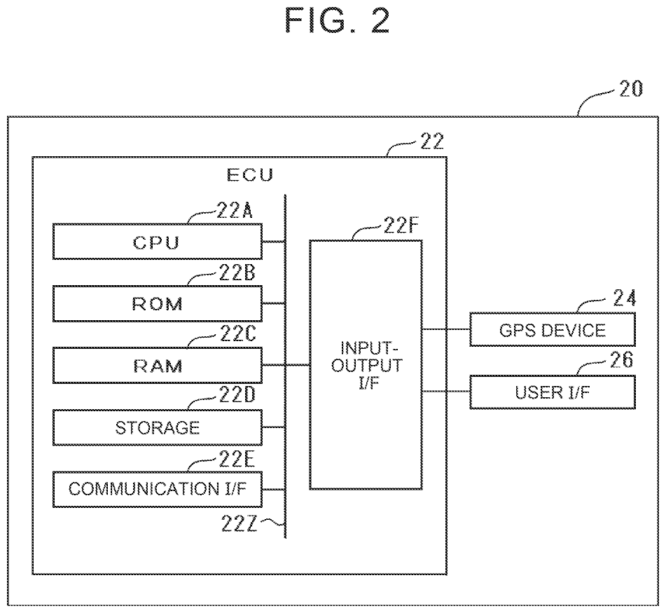

FIG. 2 is a block diagram illustrating an example of a hardware configuration of the in-vehicle device 20 according to the present embodiment. As illustrated in FIG. 2, the in-vehicle device 20 includes an Electrical Control Unit (ECU) 22, Global Positioning System (GPS device 24 and a user interface (abbreviated as “user UF” in FIG. 2) 26.

GPS device 24 includes an antenna (not shown) for receiving a GPS, and measures the current position of the vehicle 30 (see FIG. 1). The user interface 26 is an interface when the user uses the in-vehicle device 20. The user interface 26 includes an input unit and a display unit. As an example of the user interface 26, a liquid crystal display including a touch panel that enables a user to perform a touch operation is applied.

ECU 22 includes a Central Processing Unit (CPU) 22A (processor), Read Only Memory (ROM) 22B, Random Access Memory (RAM) 22C, a storage 22D, a communication interface (abbreviated as “communication I/F” in FIG. 2), 22E, and an input/output interface (abbreviated as “input/output UF” in FIG. 2) 22F. CPU 22A, ROM 22B, RAM 22C, the storage 22D, the communication interface 22E, and the input/output interface 22F are communicably connected to each other via a buss 22Z.

CPU 22A is a central processing unit that executes various programs and controls each unit. That is, CPU 22A reads the program from ROM 22B or the storage 22D, and executes the program using RAM 22C as a working area.

ROM 22B stores various programs and various data. RAM 22C temporarily stores a program/data as a working area. The storage 22D is constituted by a storage device such as Hard Disk Drive (HDD) or Solid State Drive (SSD). The storage 22D stores various programs and various data. In the present embodiment, ROM 22B or the storage 22D stores a program for outputting disaster information, a safety route guidance program, and a disaster information referencing program.

The communication interface 22E is an interface for communicating with the satellite image servers 10 (see FIG. 1) and the like (in other words, an interface for connecting to the network N). For the communication, for example, wireless communication standards such as fourth generation (4G), fifth generation (5G), and Wi-Fi (registered trademark) are used.

The input/output interface 22F is an interface for communicating with devices mounted on the vehicles 30 (see FIG. 1). In the in-vehicle device 20 of the present embodiment, GPS device 24 and the user interface 26 are exemplarily connected to ECU 22 via an input/output interface 22F.

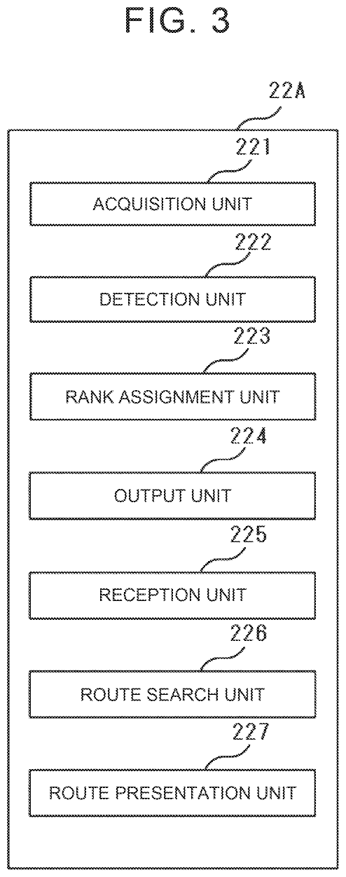

FIG. 3 is a block-diagram illustrating an exemplary functional configuration of CPU 22A. As illustrated in FIG. 3, CPU 22A includes, as functional components, an acquisition unit 221, a detection unit 222, a rank assignment unit 223, an output unit 224, a reception unit 225, a route search unit 226, and a route presentation unit 227.

The acquisition unit 221, the detection unit 222, the rank assignment unit 223, and the output unit 224 illustrated in FIG. 3 are realized by CPU 22A illustrated in FIG. 2 reading and executing a disaster-information output program stored in a ROM 22B or a storage 22D. In addition, the reception unit 225, the route search unit 226, and the route presentation unit 227 illustrated in FIG. 3 are realized by CPU 22A illustrated in FIG. 2 reading and executing the safety route guidance program stored in ROM 22B or the storage 22D.

The acquisition unit 221 illustrated in FIG. 3 acquires the latest satellite image of the region including the traveling road of the vehicle at predetermined time intervals. The latest satellite image is acquired from the satellite image server 10 (see FIG. 1).

The detection unit 222 detects a change in the shape of the traveling road and an obstacle on the traveling road based on the satellite image acquired by the acquisition unit 221. As an example, the detection unit 222 compares an image of only the traveling road stored in advance with the latest satellite image acquired by the acquisition unit 221 using a known image recognition technique. Then, the detection unit 222 detects a change in the shape of the traveling road and an obstacle on the traveling road. Note that the change in the shape of the traveling road includes, for example, a change in the shape of the traveling road in which the expressway has collapsed. The obstacles on the traveling road include earth and sand due to landslides, fallen stones, flying objects, etc. Vehicles and persons traveling on the traveling road are not included in obstacles on the traveling road.

Further, in the present embodiment, the detection unit 222 further detects embankments around the traveling road based on the satellite image acquired by the acquisition unit 221. As an example, the detection unit 222 detects the embankment around the traveling road from the image around the traveling road among the satellite images acquired by the acquisition unit 221 by using a known image recognition technique.

The rank assignment unit 223 assigns a danger level rank to a section obtained by dividing the traveling road based on the satellite image acquired by the acquisition unit 221. As an example, the danger level rank may be classified into an A rank indicating a dangerous state that cannot be passed at all or a dangerous state that is highly likely to become unable to pass in the future, a B rank indicating a state that does not correspond to the A rank and is capable of passing through itself but is unable to pass as usual, and a C rank indicating a state that is capable of passing as usual. The danger level rank may be further subdivided.

Here, in the present embodiment, as an example, the rank assignment unit 223 estimates the danger level of each section of the traveling road using the machine learning model, and assigns the danger level rank based on the estimated danger level. In addition, the rank assignment unit 223 inputs the latest satellite image acquired by the acquisition unit 221 to the machine learning model in which the danger level of the traveling road and the satellite image are learned as the data set. Accordingly, the rank assignment unit 223 estimates the danger level of each section of the traveling road.

The output unit 224 outputs a detection result by the detection unit 222. Further, the output unit 224 further outputs the danger level rank assigned by the rank assignment unit 223 in association with the section of the traveling road.

In addition, the reception unit 225 receives each piece of information on the current position and the destination of the vehicle 30. For example, the reception unit 225 receives the measured value of GPS device 24 as the current position of the vehicle 30, and receives the destination information inputted using the user interface 26.

The route search unit 226 searches for a route that is a route from the current position of the vehicle 30 to the destination and has a danger level rank lower than a predetermined rank, based on the information received by the reception unit 225 and the danger level rank assigned by the rank assignment unit 223. The route presentation unit 227 outputs the route searched by the route search unit 226.

### Operation of the Embodiment

Next, the operation of the in-vehicle device 20 shown in FIG. 2 will be described.

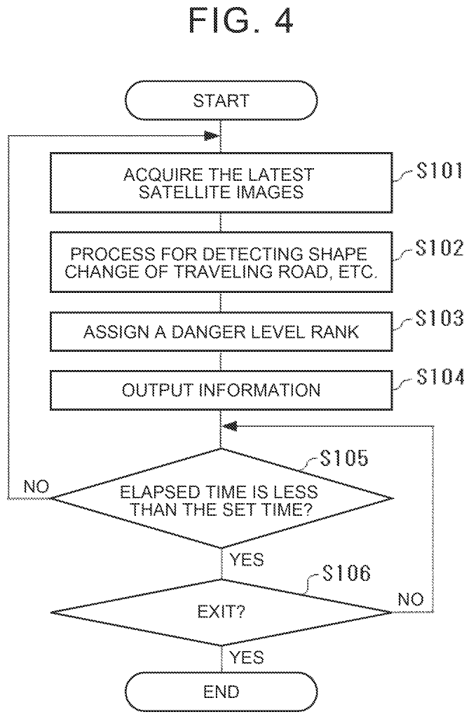

FIG. 4 is a flowchart illustrating an example of a flow of a disaster information output process. CPU 22A reads a program for outputting disaster information from a ROM 22B or a storage 22D, develops the program in a RAM 22C, and executes the program, thereby performing a disaster information output process. Note that the processing illustrated in FIG. 4 is executed by, for example, turning on an ignition switch (not illustrated) of the vehicle 30.

First, CPU 22A obtains the most recent satellite image from the satellite image servers 10 (S101). Next, CPU 22A performs a process of detecting a change in the profile of the traveling road, an obstacle on the traveling road, and embankment around the traveling road based on the satellite images acquired by S101 (S102).

Next, CPU 22A assigns a danger level rank ranking to a section obtained by dividing the traveling road based on the detected S102 (S103). In S103, CPU 22A estimates a danger level of each section of the traveling road by using a machine learning model. CPU 22A assigns a danger level ranking based on the estimated risk.

CPU 22A then outputs the detection result in S102 and information on the danger level rank assigned in S103 to the storage 22D (S104). Here, the danger level rank is outputted to the storage 22D in association with the section of the traveling road. By S104 process, S102 is detected and the danger level ranks assigned in S103 are stored in the storage 22D.

Next, CPU 22A determines whether or not the elapsed time after S104 is executed is less than a set time (a preset time) (S105). When the elapsed time after S104 is executed reaches the set time (S105:N), CPU 22A repeats the process from S101. When the elapsed time after S104 is executed is less than the set time (S105:Y), CPU 22A determines whether or not there is an instruction to terminate based on whether or not an ignition switch (not shown) is turned off or the like (S106).

If there is no termination instruction (S106:N), CPU 22A returns to S105 process. When there is an instruction to terminate (S106:Y), CPU 22A terminates the process based on the disaster-information-outputting program.

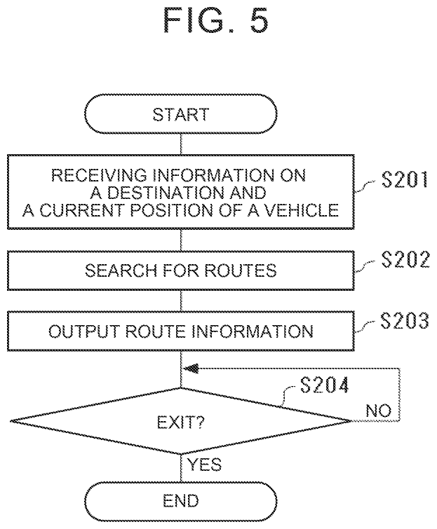

FIG. 5 is a flowchart illustrating an example of a flow of route guidance processing. CPU 22A reads the safety route guidance program from ROM 22B or the storage 22D, expands the program in RAM 22C, and executes the program. Thus, CPU 22A performs a route guidance process. When the destination information is input from the user interface 26, the execution of the route guidance processing illustrated in FIG. 5 is started.

First, CPU 22A receives destination information and receives information from GPS device 24, that is, information on the current position of the vehicles 30 (S201). Next, CPU 22A searches for a route that is a route from the current position of the vehicle 30 to the destination and has a danger level rank lower than a predetermined rank (for example, the above-described B rank) based on the current position of the vehicle 30 and the information on the destination and the danger level rank stored in the storage 22D (S202). Next, CPU 22A displays the route searched by S202 on the map of the liquid crystal display of the user interface 26 (S203).

Next, CPU 22A determines whether or not there is an instruction to terminate the route indication based on the manipulation of the user interface 26 or the like (S204). When there is no instruction to end the display output of the route information (S204:N), CPU 22A waits until there is an instruction to end the display output of the route information. When there is an instruction to end the display output of the route information (S204:Y), CPU 22A ends the display output of the route information. Then, CPU 22A ends the process based on the safety route guidance program.

When the in-vehicle device 20 illustrated in FIG. 2 is operated to refer to disaster information in a predetermined area (for example, a surrounding area) from the user interface 26, CPU 22A reads the disaster information reference program from ROM 22B or the storage 22D, expands the program on RAM 22C, and executes the program, thereby performing a disaster information displaying process. Although the flow chart is not shown, when the disaster information referencing program is executed, CPU 22A reads the data stored in the storage 22D and displays, on the liquid crystal display of the user interface 26, the change in the shape of the traveling road and the information on the obstacles on the traveling road, the information on the embankment around the traveling road, and the information on the danger level rank associated with the section of the side-by-side traveling road. Further, when the user interface 26 is operated to terminate the referencing of the disaster information, CPU 22A terminates the process of displaying the disaster information on the liquid crystal display of the user interface 26.

As described above, according to the present embodiment, it is possible to provide the disaster information on the traveling road of the vehicle regardless of the information from the vehicle.

Further, in the present embodiment, since the shape change of the traveling road and the obstacle on the traveling road are detected based on the satellite image regardless of the information from the vehicle, for example, it is possible to detect a vehicle that is difficult to detect from the wheel speed data obtained by the communication from the vehicle. Supplementarily, basically, a driver of a vehicle drives to avoid small shape-changing parts of a road surface, such as a pothole, and small obstacles. Therefore, it is difficult to detect a small shape change portion and a small obstacle on the road surface from the wheel speed data. On the other hand, in the present embodiment, since the shape change of the traveling road and the obstacle on the traveling road are detected based on the satellite image, it is possible to detect a small shape change portion of the road surface and a small obstacle.

In addition, in the present embodiment, it is possible to provide information on the embankment around the traveling road of the vehicle. Therefore, the driver of the vehicle 30 shown in FIG. 1 can grasp the disaster risk caused by the embankment.

In addition, in the present embodiment, it is possible to provide information on the danger level rank of each section of the traveling road. Therefore, the driver of the vehicle 30 can easily grasp the danger level of each section. Further, in the present embodiment, the danger level is estimated using the machine learning model. Therefore, it is possible to present a more accurate danger level rank. In addition, in the present embodiment, by using the machine learning model, the rank assignment unit 223 (see FIG. 3) can estimate the danger level by predicting, for example, earth and sand collapse, spread of flooding, and the like. Therefore, it is possible to give a more accurate danger level rank.

Further, in the present embodiment, it is possible to provide information on a route with a low danger level. Therefore, the driver of the vehicle 30 can easily know a safer route and can safely drive the vehicle.

### Supplementary Description of Embodiment

In the above-described embodiments illustrated in FIGS. 1 to 5, the in-vehicle device 20 is applied as an information processing device. However, the information processing device may be, for example, a server that is not mounted on the vehicle and can output information to the in-vehicle device or the user terminal.

In the above-described embodiment, the satellite images captured by the satellites are sequentially stored in the satellite image server 10, and the in-vehicle device 20 acquires the latest satellite images from the satellite image server 10. However, for example, the satellite images captured by the satellites may be stored in the storage 22D of the in-vehicle device 20 in direct order, and CPU 22A may acquire the most recent satellite images at predetermined time-intervals from the databases of the satellite images.

In the above-described embodiment, the detection unit 222 detects both a change in the shape of the traveling road and an obstacle on the traveling road based on the satellite image acquired by the acquisition unit 221. As a modification of the above-described embodiment, the detection unit 222 may detect one of a change in the shape of the traveling road and an obstacle on the traveling road based on the satellite image acquired by the acquisition unit 221.

Further, in the above-described embodiment, the detection unit 222 detects embankments around the traveling road based on the satellite image acquired by the acquisition unit 221. As a modification of the above-described embodiment, the detection unit 222 may be configured not to detect embankments around the traveling road.

Further, in the above-described embodiment, the in-vehicle device 20 includes a rank assignment unit 223 that assigns a danger level rank to a section obtained by dividing the traveling road based on the satellite image acquired by the acquisition unit 221. As a modification of the above-described embodiment, the configuration in which the in-vehicle device 20 does not include the rank assignment unit 223 may be adopted.

Further, in the above-described embodiment, the rank assignment unit 223 estimates the danger level of each section of the traveling road using the machine learning model, and assigns the danger level rank based on the estimated danger level. As a modification of the above-described embodiment, the rank assignment unit 223 may assign the danger level rank based on the magnitude of the change in the shape of the traveling road and the magnitude of the obstacle on the traveling road, which are recognized from the satellite image acquired by the acquisition unit 221. Further, as another modification, the rank assignment unit 223 may assign the danger level rank based on the position of the shape change portion of the traveling road and the position of the obstacle on the traveling road, which are recognized from the satellite image acquired by the acquisition unit 221.

Further, in the above-described embodiment, the in-vehicle device 20 includes the route search unit 226 that searches for a route from the current position of the vehicle 30 to the destination based on the information received by the reception unit 225 and the danger level rank assigned by the rank assignment unit 223, and whose danger level rank is lower than a predetermined rank. As a modification of the above-described embodiment, a configuration in which the in-vehicle device 20 does not include the route search unit 226 may be adopted.

In addition, as a modification of the above-described embodiment, CPU 22A may be configured to detect a point where the vehicle performs meandering driving in the satellite image based on the most recent satellite image acquired from the satellite image server 10. In addition, CPU 22A may be configured to detect a change in the profile of the traveling road and an obstacle on the traveling road at the detected point with higher accuracy than at other points.

In addition, in the above-described embodiment, various processors other than CPU may execute the respective processes executed by CPU 22A reading the software (program). Examples of the processor include a Programmable Logic Device (PLD in which a circuit configuration can be changed after manufacturing of Field-Programmable Gate Array (FPGA, and the like, and a dedicated electric circuit that is a processor having a circuit configuration designed exclusively for executing a particular process such as Application Specific Integrated Circuit (ASIC, and the like. Further, the respective processes may be executed by one of the various processors, or may be executed by a combination of two or more processors (for example, a plurality of FPGA, a combination of CPU and FPGA, and the like) of the same type or different types. The hardware structure of each of the various processors is, more specifically, an electric circuit in which circuit elements such as semiconductor elements are combined.

The program for outputting disaster information, the safety route guidance program, and the disaster information referencing program described in the above embodiments may be provided in a form recorded in a recording medium such as Compact Disc Read Only Memory (CD-ROM), Digital Versatile Disc Read Only Memory (DVD-ROM), and Universal Serial Bus (USB). Further, the program may be downloaded from an external device via a network.

The present embodiment and several modifications described above can be carried out by appropriately combining the above embodiment and modifications thereof.

The example of the present disclosure has been described as above. However, it is not without saying that the present disclosure is not limited to the above example, and in addition to the above example, the present disclosure can be appropriately modified to be implemented without departing from the scope thereof.

What is claimed is:

1. An information processing device comprising:
an acquisition unit that acquires a latest satellite image of a region including a traveling road of a vehicle at a predetermined time interval;
a detection unit that detects at least one of a change in a shape of the traveling road and an obstacle on the traveling road based on the satellite image acquired by the acquisition unit; and
an output unit that outputs a detection result by the detection unit.

2. The information processing device according to claim 1, wherein the detection unit further detects embankment around the traveling road based on the satellite image acquired by the acquisition unit.

3. The information processing device according to claim 1, further comprising a rank assignment unit that assigns a danger level rank to a section that is a divided section of the traveling road based on the satellite image acquired by the acquisition unit, wherein the output unit further outputs the danger level rank assigned by the rank assignment unit in association with a section of the traveling road.

4. The information processing device according to claim 3, further comprising:
a reception unit that receives information on each of a current position of the vehicle and a destination;
a route search unit that searches for a route from the current position of the vehicle to the destination and having the danger level rank that is lower than a predetermined rank based on the information received by the reception unit and the danger level rank assigned by the rank assignment unit; and
a route presentation unit that outputs the route searched by the route search unit.

5. The information processing device according to claim 3, wherein the rank assignment unit estimates a danger level of each section of the traveling road using a machine learning model, and assigns the danger level rank based on the estimated danger level.
